(19) United States
(12) Patent Application Publication
(10) Pub. No.: US 2010/0092768 A1
(43) Pub. Date: Apr. 15, 2010

(54) Pressure-sensitive adhesive tape with functionalized adhesive and use thereof

(75) Inventors: Ingo Neubert, Norderstedt (DE); Maren Kampers, Seevetal (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: tesa AG, Hamburg (DE)

(21) Appl. No.: 12/250,058

(22) Filed: Oct. 13, 2008

(51) Int. Cl. B32B 5/00; B32B 33/00; B05D 3/00; B32B 27/30

(52) U.S. Cl. 428/337; 428/343; 428/354; 428/355 R; 428/355 EN; 427/372.2; 427/384

(57) ABSTRACT

Pressure-sensitive adhesive tape having a backing material coated on one or both sides with a pressure-sensitive adhesive, wherein at least one surface of pressure-sensitive adhesive is functionalized by an additional surfactant-containing coating, the functionalization of the surface of pressure-sensitive adhesive being retained even after a storage time of 6 weeks at 40° C., and the bond strength to steel of the functionalized pressure-sensitive adhesive being at least 0.5 N/cm.

The present invention relates to a pressure-sensitive adhesive tape which through functionalization of the pressure-sensitive adhesive allows sustained and rapid spreading or sustained and rapid transport of biological fluids such as, for example, blood, urine, saliva or cellular fluid.

In modern medical diagnostics an ever greater number of analytical aids is being used, including, for example, what are known as microfluidic devices. Microfluidic devices are biosensors and bio chips which can be used to carry out procedures in molecular biology, such as mixing, separating, cleaving and/or copying of proteins, enzymes or nucleic acids, for example, and also to carry out analyses outside of the human body (in vitro diagnostics, IVD) with very small amounts of biological fluids such as blood, saliva, cellular fluid and urine. These devices include test strips, known as diagnostic test strips or biosensors, in which enzymatic reactions allow the determination, for example, of the amount of glucose, lactate, cholesterol, proteins, ketones, phenylalanine or enzymes in biological fluids. The most frequently encountered are diagnostic test strips for determining and checking the blood sugar content, for diabetics. Other examples of microfluidic devices are DNA chips, DNA microarrays and immunoassays for detecting and analyzing diseases, and sensors for detecting pathogens and toxins.

These applications are disclosed exemplarily in US 2002/0112961 A1, U.S. Pat. No. 6,601,613 B2, U.S. Pat. No. 7,125,711 B2, EP 1 525 916 A1 (microfluidic devices), DE 102 34 564 A1, U.S. Pat. No. 5,759,364 A1 (biosensor), WO 2005/033698 A1, and U.S. Pat. No. 5,997,817 A1 (blood sugar test strips). In all microfluidic devices, for the molecular-biological procedures and analyses in question, small amounts of fluid, in some cases in the region of a few microliters, are passed through a channel or a channel system. This fluid transport is realized either by means of external forces, such as pumps or centrifugal forces, or without external forces, solely by means of capillary forces. Depending on the mode of operation of the microfluidic devices, functionalizing the walls of the channel system is necessary for effective and reliable fluid transport and for its control.

### BRIEF DESCRIPTION OF THE DRAWINGS

The present invention will be described in greater detail with reference to the drawings, wherein:

FIG. 1 is a schematic depicting one embodiment of a pressure-sensitive adhesive tape according to the present invention;

FIG. 2 is a schematic illustrating equation 1 below; and

FIG. 3 is a schematic illustrating equation 2 below.

In the literature there are various studies on the topics of capillarity and transport of liquids in capillaries. The capillary pressure, and the ascension of a column of liquid in a capillary, are dependent on the surface tension of the liquid, the viscosity of the liquid, the wetting angle and the capillary diameter. The ascension is determined in accordance with the following formula (equation 1 (eq.1)):

$$h = \frac{4 * {γ}_{l} * cos θ}{g ( {ζ}_{l} - {ζ}_{g} ) * d} \qquad eq . 1$$

h—ascension or depression

γₗ—surface tension of the liquid

ζₗ—density of the liquid

ζ_{g}—density of the gas (air)

g—acceleration due to gravity

θ—contact angle (wetting angle)

d—internal diameter of the capillary

FIG. 2 illustrates equation 1.

From this equation it is evident that the capillary forces increase as the capillary diameter goes down. A reduction in flow rate in a capillary can therefore be achieved by increasing the cross section of a microchannel. A further important parameter affecting the flow rate of a given liquid is the surface tension of the inside of the channel, whereas for a given liquid it is not possible to vary the parameter of the viscosity.

In the case of a very small wetting angle between liquid and capillary wall, capillary ascension occurs—that is, the liquid rises in the capillary. At a contact angle of>90°, however, there is capillary depression, and the level of liquid in the capillary is below the liquid level (W. Bohl “Technische Strömungslehre”, 13th, revised and expanded edition, Vogel Verlag, June 2005, ISBN: 3834330299, page 37f).

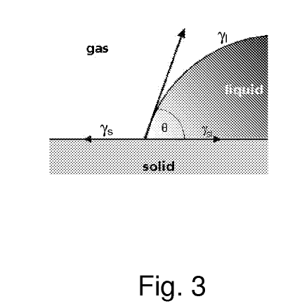

In the literature there are numerous studies on surface tension and on the phenomenon of the wettability of solids. The wetting of a solid by a liquid is described by Young's equation (eq. 2) (in this connection see FIG. 3)

γₗ·cos θ=γₛ−γₛₗ eq. 2

θ—contact angle (wetting angle)

γₗ—surface tension of the liquid

γₛ—surface tension of the solid

γₛₗ—interfacial tension between the liquid and the solid

If the surface tensions of the solid and of the liquid are significantly different, a contact angle θ>>90° is obtained. The surface of the solid is not wetted by the liquid. In the range from 90° to 20°, wetting of the solid's surface occurs. At contact angles θ<20°, the surface tensions between liquid and solid are very similar, and the surface of the solid is wetted very well by the liquid. At contact angles θ<<20° (θ˜0°), the liquid spreads out on the surface of the solid.

The literature describes the use of surfactants, which the skilled person knows as substances with interface activity, for improving the wettability of a solid's surface. Surfactants are molecules or polymers which consist of an apolar/hydrophobic portion (tail) and a polar/hydrophilic group (head). To improve the wettability of surfaces, the surfactants are usually added to the aqueous liquid. The surfactant brings about a reduction in the surface tension of the aqueous liquid at the interfaces (liquid-solid and liquid-gaseous). This effect of improving the wettability of the surfaces is measurable in a reduction in the contact angle and in a reduction in the surface tension of the liquid. The skilled person distinguishes between anionic, cationic, amphoteric and nonionic surfactants. The hydrophobic tail of surfactants may consist of linear or branched alkyl, alkylbenzyl, perfluorinated alkyl or siloxane groups. Possible hydrophilic head groups are anionic salts of carboxylic acids, phosphoric acids, phosphonic acids, sulfates, sulfonic acids, cationic ammonium salts or nonionic polyglycosides, polyamines, polyglycol esters, polyglycol ethers, polyglycol amines, polyfunctional alcohols or alcohol ethoxylates.

In principle, an improvement in the wettability of the inside of the channels of the test strips and biosensors produces an increase in the rate of transport of the biological fluid within the channels. Hydrophilic coatings with polar polymers such as polyvinylpyrrolidone, polycaprolactam, polyethylene glycol or polyvinyl alcohol, for example, as are disclosed in US 2008/0003348 A1, U.S. Pat. No. 5,262,475 A1 or EP 1 862 514 A1, or physical or chemical surface treatments, as disclosed in WO 2005/111606 A1, lead to an increase in the surface tension and hence to improved wettability of the channel walls. The surface may likewise be modified by means of a plasma treatment. By incorporating gases or organic substances into the plasma zone it is possible to tailor the surface properties. For instance, both hydrophilic and hydrophobic layers can be generated on the surface. The application of this method is described in U.S. Pat. No. 6,955,738 B2.

There are also some examples in which a surfactant is applied to the surface of the solid in order to improve the wetting of the surface. Corresponding hydrophilic films for use in medical diagnostic strips and microfluidic devices are already available commercially today, an example being the products 9962 and 9971 from 3M Inc., whose use is shown in US 2002/0110486 A1 and EP 1 394 535 A1. These products have a polyester film which is equipped on either one side or both sides with a hydrophilic coating. Said coating consists of a polyvinylidene chloride coating comprising a surfactant based on an alkylbenzylsulfonate. The surfactant must first migrate to the surface of the coating before the hydrophilic surface properties can be developed. This surfactant-containing coating is significantly more effective for fluid transport than the hitherto-described modifications by means of a polar polymer coating or a physical surface treatment. A detailed investigation, however, shows that these products, although suitable for the transport of biological fluids in diagnostic strips, exhibit considerable deficiencies in terms of homogeneity, transport rate and aging stability. US 2008/0176068 A1 likewise describes a corresponding hydrophilic film consisting of a polyester film with a very thin coating of surfactant comprising, preferably, a sodium succinic ester.

The aforementioned hydrophilic films are used as lids or covers for the channels and channel systems in biosensors and microfluidic devices. The purpose of the hydrophilic films in such systems is to ensure rapid fluid transport. In the construction of the biosensor it is necessary to affix the hydrophilic film by means of an additional adhesive layer. This entails further difficulties in terms of design, production and compatibilities.

An improvement in this respect is shown by the commercially available hydrophilic films ARflow® 90128 and ARflow® 90469 from Adhesives Research Inc., which are equipped with a hydrophilic, heat-sealable adhesive, whose use is shown in WO 02/085185 A2. The heat-sealable adhesive used is a thermoplastic copolyester, with addition of a surfactant. The mode of action is analogous to that of the above-described products from 3M Inc. The specification likewise describes the preparation and use of hydrophilic, surfactant-containing pressure-sensitive adhesives. In order for a sufficient amount of surfactant to migrate to the surface of the adhesive, and hence for a fluid transport effect to be obtained, it is necessary to add a considerable amount of surfactant, >6% by weight, to the pressure-sensitive adhesive. In this large amount, the surfactant acts like a plasticizer in the adhesive composition. As a result there is considerable impairment to the properties of the pressure-sensitive adhesive.

WO 2004/061029 A2 describes an adhesive tape with a pressure-sensitive adhesive which likewise comprises a surfactant, a polar polymer or a combination of the two. The amount of surfactant relative to the pressure-sensitive adhesive is, in the preferred embodiment, likewise 5% to 10% by weight.

It is an object of the present invention to functionalize the surface of the pressure-sensitive adhesive of a substantially two-dimensional pressure-sensitive adhesive tape in such a way that it is suitable, in accordance with the requirements, for use in biosensors, diagnostic test strips and microfluidic devices, and for their construction, and, specifically, permits transport of the biological fluid into and through the measurement channels. In this context it is also necessary to ensure that the properties, and especially the wetting properties and transport properties, of the functionalized pressure-sensitive adhesive are retained even after a long storage time.

This object is achieved by means of a pressure-sensitive adhesive tape as recorded in the main claim. The dependent claims provide advantageous developments of the subject matter of the invention. The invention further encompasses the possibility for use of the pressure-sensitive adhesive tape of the invention in applications including medical diagnostic strips for the analysis of biological fluids.

The invention accordingly provides a pressure-sensitive adhesive tape consisting of a backing material coated on one or both sides with a pressure-sensitive adhesive, at least one surface of the pressure-sensitive adhesive being functionalized by means of an additional surfactant-containing coating, the effect of the functionalization being retained even after a storage time of at least 6 weeks at not less than 40° C. The functionalized pressure-sensitive adhesive has a bond strength to steel of at least 0.5 n/cm and, advantageously, of at least 1.0 N/cm, and more preferably of at least 1.5 N/cm.

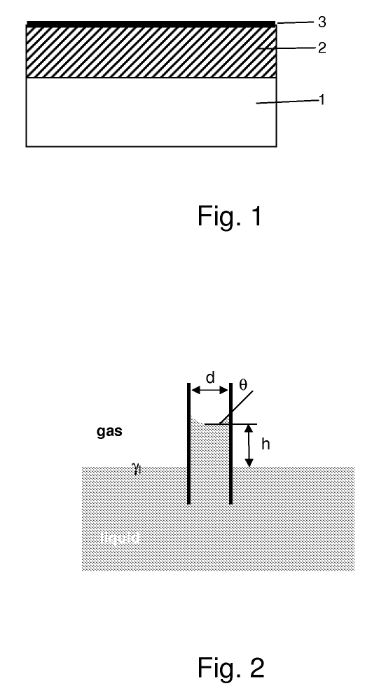

A figurative diagram of the pressure-sensitive adhesive tape of the invention is shown by FIG. 1. That figure shows the pressure-sensitive adhesive tape with a backing material 1, on one side of which a pressure-sensitive adhesive 2 is applied. Applied to the pressure-sensitive adhesive 2, in turn, is the surfactant-containing coating 3, the coating 3 having not diffused, or having diffused only partially, into the pressure-sensitive adhesive 2.

A considerable advantage of a subsequent functionalization derives from the fact that with this process it is possible to carry out functionalization of any desired pressure-sensitive adhesives and pressure-sensitive adhesive tapes.

In the preferred embodiment the pressure-sensitive adhesive is composed of one or more copolymers, with acrylate monomers forming the principal constituents.

With further preference the surface of the pressure-sensitive adhesive is functionalized by a coating with an ionic surfactant, preferably an anionic surfactant, which may also comprise fluoroalkyl chains, the coating preferably comprising a sulfosuccinic ester salt as surfactant. More preferably the coating, after drying, is composed exclusively of a sodium bis-2-ethylhexyl sulfosuccinate or sodium dioctyl sulfosuccinate, without further adjuvants.

Backing materials used for the pressure-sensitive adhesive tape (PSA tape) of the invention are the backing materials that are customary and familiar to the skilled person, such as films of polyester, polyethylene, polypropylene, polyvinyl chloride, more preferably films of polyethylene terephthalate (PET). These backing films may be monoaxially or biaxially oriented and may also be constructed as a multilayer film in a coextrusion process. This enumeration should not be considered conclusive; instead, within the bounds of the invention, further films may be used. Preference is given to using a backing film of polyethylene terephthalate (PET) in a thickness of 12 to 350 μm and preferably 50 to 150 μm. To improve the adhesion or anchorage of the adhesive on the backing film it is possible for a primer coating to be applied between backing film and pressure-sensitive adhesive or, preferably, for a physical surface treatment by means of flaming, corona or plasma to be undertaken.

As pressure-sensitive adhesive (PSA) for the PSA tape of the invention it is possible for there to be the PSAs that are known to the skilled person and are based on natural rubber, synthetic rubbers such as homopolymers or copolymers of polyisoprene, of polybutadiene, of 1-butene, of polyisobutylene, of vinyl acetate and also styrene block copolymers or, with particular preference, based on copolymers or copolymer mixtures composed of acrylic esters. The PSA is coated on the backing film on one or both sides with an adhesive coat weight (after drying) of preferably from 8 to 100 g/m² and more preferably 12 to 50 g/m². Coating with the PSA may take place from a solvent, in the form of a dispersion or in the form of a 100% system, by extrusion, for example.

The PSA of the PSA tape is composed in the preferred embodiment of one or more copolymers comprising at least the following monomers:
c1) 70% to 100% by weight of acrylic esters and/or methacrylic esters or their free acids, with the following formula

CH₂═CH(R₁)(COOR₂),
where R₁ is H and/or CH₃ and R₂ is H and/or alkyl chains having 1 to 30 C atoms.

Here it is possible for the parent monomer mixture to have had
c2) up to 30% by weight of olefinically unsaturated monomers with functional groups added to it as a further component.

In one very preferred version use is made for the monomers c1) of acrylic monomers which comprise acrylic and methacrylic esters with alkyl groups consisting of 4 to 14 C atoms, preferably 4 to 9 C atoms. Specific examples, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate, stearyl acrylate, behenyl acrylate, and their branched isomers such as, for example, t-butyl acrylate and 2-ethylhexyl acrylate.

Further classes of compound which may likewise be added in small amounts under c1) are methyl methacrylates, cyclohexyl methacrylates, isobornyl acrylate and isobornyl methacrylates.

In one very preferred version use is made for the monomers c2) of vinyl esters, vinyl ethers, vinyl halides, vinylidene halides, vinyl compounds with aromatic rings and heterocycles in α position. Here again mention may be made of a number of examples, without the enumeration being considered conclusive:
vinyl acetate, vinylformamide, vinylpyridine, ethyl vinyl ether, vinyl chloride, vinylidene chloride and acrylonitrile.

Another very preferred version uses, for the monomers c2), monomers having the following functional groups:
hydroxyl, carboxyl, epoxy, acid amide, isocyanato or amino groups.

In one advantageous variant acrylic monomers are used for c2) that conform to the general formula

CH₂═CH(R₁)(COOR₃),
where R₁ is H or CH₃ and the radical R₃ represents or constitutes a functional group which supports subsequent UV crosslinking of the PSA and which, for example, in one particularly preferred version possesses an H donor effect.

Particularly preferred examples for component c2) are hydroxyethyl acrylate, hydroxypropyl acrylate, hydroxyethyl methacrylate, hydroxypropyl methacrylate, allyl alcohol, maleic anhydride, itaconic anhydride, itaconic acid, acrylamide and glyceridyl methacrylate, benzyl acrylate, benzyl methacrylate, phenyl acrylate, phenyl methacrylate, t-butylphenyl acrylate, t-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylamino-ethyl acrylate, cyanoethyl methacrylate, cyanoethyl acrylate, glyceryl methacrylate, 6-hydroxyhexyl methacrylate, N-tert-butylacrylamide, N-methylolmethacrylamide, N-(buthoxymethyl)methacrylamide, N-methylolacrylamide, N-(ethoxymethyl)acrylamide, N-isopropylacrylamide, vinylacetic acid, tetrahydrofurfuryl acrylate, β-acryloyloxypropionic acid, trichloroacrylic acid, fumaric acid, crotonic acid, aconitic acid, dimethylacrylic acid, this enumeration not being understood as being conclusive.

In a further preferred embodiment use is made for component c2) of aromatic vinyl compounds, where the aromatic nuclei may preferably be composed of C₄ to C₁₈ and may also contain heteroatoms. Particularly preferred examples are styrene, 4-vinylpyridine, N-vinylphthalimide, methylstyrene, 3,4-dimethoxystyrene, 4-vinylbenzoic acid, this enumeration not being considered as being conclusive.

For preparing the polyacrylate PSAs it is advantageous to carry out conventional free-radical polymerizations or controlled free-radical polymerizations. For the polymerizations which proceed by free-radical mechanism it is preferred to use initiator systems which further comprise additional free-radical initiators for the polymerization, more particularly thermally decomposing radical-forming azo or peroxo initiators. In principle, however, all customary initiators familiar to the skilled person for acrylates are suitable.

The inner strength (cohesion) of the polyacrylate PSA of the PSA tape of the invention is preferably heightened by crosslinking. Crosslinking the PSA increases the shear strength of the PSA tape of the invention. For the crosslinking it is possible optionally to add compatible crosslinker substances to the acrylate-containing PSAs. Particularly suitable crosslinkers are metal chelates, polyfunctional isocyanates, polyfunctional amines or polyfunctional alcohols. Crosslinking may take place in a favorable way by thermal means or by means of high-energy radiation (actinic radiation), in the latter case more particularly by electron beams (EB) or, following addition of suitable photoinitiators, by ultraviolet radiation.

To optimize the properties it is possible for the PSA employed to be blended with one or more additives such as tackifiers (resins), plasticizers, fillers, pigments, UV absorbers, light stabilizers or aging inhibitors. In the selection of the additives it should be ensured that compatibility with the biochemical detection reactions and reagents is not adversely affected. Tackifiers (resins) are, for example, hydrocarbon resins (for example polymers based on unsaturated C₅ or C₉ monomers), terpene phenolic resins, polyterpene resins from raw materials such as α- or β-pinene, for example, aromatic resins such as coumarone-indene resins or resins based on styrene or α-methylstyrene such as rosin and its derivatives, examples being disproportionated, dimerized or esterified resins, as, for example, reaction products with glycol, glycerol or pentaerythritol, to name but a few, and also further resins. With particular preference a PSA is used which is composed of a copolymer or copolymer mixture comprising acrylic esters and containing none of the stated additives; in other words, the PSA is what is called a straight acrylate PSA.

In summary the preferred embodiment of the PSA tape has a polyacrylate PSA which is manufactured by coextrusion, melt coating, solvent coating or dispersion coating. Particular preference is given to comma bar coating of the polyacrylate PSA from a suitable solvent or solvent mixture.

Where the backing film is coated with the polyacrylate PSA on one side, the reverse of the backing film may be coated with one of the known release agents (blended where appropriate with other polymers). Examples are stearyl compounds (for example polyvinylstearyl carbamate, stearyl compounds of transition metals such as Cr or Zr, ureas formed from polyethyleneimine and stearyl isocyanate), polysiloxanes (in the form for example of a copolymer with polyurethanes or of a graft copolymer on polyolefin), thermoplastic fluoropolymers. The term stearyl stands as a synonym for all linear or branched alkyls or alkenyls having a C number of at least 10, such as octadecyl, for example.

The PSA tape may likewise comprise the commercial release films typically composed of a base material of polyethylene, polypropylene, polyester or paper with a single-sided or double-sided polysiloxane coating. The release film may be laminated on one or both sides of the PSA tape (in the case of a double-sided PSA coating) and serves for greater ease of unwind and processing of the PSA tape.

The hydrophilic coating for the subsequent functionalization of the PSA is composed of a surfactant-containing coating which is preferably applied to the surface of the adhesive from a solvent and dried. The surfactant-containing coating comprises at least one surfactant and may likewise include further additions such as, for example, polymers as binders or thickeners. The surfactant is critically responsible for the functionalization of the PSA. Surfactants which can be used include compounds comprising linear or branched alkyl, alkylbenzyl, perfluorinated alkyl or siloxane groups with hydrophilic head groups, such as anionic salts of carboxylic acids, phosphoric acids, phosphonic acids, sulfates, sulfonic acids, sulfosuccinic acid, cationic ammonium salts or nonionic polyglycosides, polyamines, polyglycol esters, polyglycol ethers, polyglycol amines, polyfunctional alcohols or alcohol ethoxylates. This selection is an exemplary enumeration and does not represent any restriction of the inventive concept to the surfactant specified.

By way of example the following suitable surfactants may be specified:
nonionic fluorosurfactants, for example Fluorad FC-4430 and FC-4432 from 3M Inc., Zonyl® FSO-100 from DuPont Inc. and Licowet® F 40 from Clariant AG
ionic fluorosurfactants, for example Zonyl® FSA from DuPont Inc. and Chemguard S-228M from Chemguard Inc.
nonionic silicone surfactants, for example Q2-5211 and Sylgard® 309 from Dow Corning Inc., Lambent® 703 from Lambent Technologie Inc. and Tegopren® 5840 from Evonik AG
ionic alkyl sulfate salt, for example Rewopol® NLS 28 from Evonik GmbH
ionic sulfosuccinic salts, for example Lutensit® A-BO from BASF AG or Rewopol® SB DO from Evonik GmbH.

In the application of a surfactant-containing coating to a pressure-sensitive adhesive there are a variety of difficulties observed. On the one hand, the surfactant forms a surfactant layer on the PSA surface. The surfactant layer on the surface leads to very good wettability, but also to hydrophilic functionalization of the PSA surface. This surfactant layer, however, likewise leads to a loss of the pressure-sensitive adhesion properties of the adhesive. Bonding of the PSA is no longer possible, or is possible only with great restrictions. On the other hand it is observed, surprisingly, that coatings with a multiplicity of surfactants in turn do not produce any improvement in wettability. It is supposed that these surfactants are very highly compatible with the adhesive and migrate completely into the PSA, and thus have no effect at all on the wettability at the adhesive's surface. Surprisingly and unforeseeably for the skilled person, anionic surfactants, and especially sulfosuccinic salts or carboxylic or phosphoric salts with fluoroalkyl chains emerge as being particularly suitable at resolving the apparent irreconcilability between incompatibility with the PSA, which is a condition for the storage-stable functionalization of the PSA surface, and the associated loss of tack in comparison to high compatibility but associated lack of hydrophilic functionalization of the PSA surface. It proves to be especially suitable to use sodium diisooctyl sulfosuccinate (CAS number 577-11-7) as a surfactant for the coating of the PSA.

The concentration of surfactant or surfactants in the surfactant-containing coating solution is not more than 30% by weight and preferably not more than 20% by weight. This produces on the PSA surface, after drying, a surfactant-containing coating with a thickness of not more than 1 μm and advantageously not more than 0.5 μm. This thickness applies, however, only to a uniform coating over the full area.

The functionalized PSA of the PSA tape of the invention features very good wetting performance for aqueous and biological fluids. The very good wetting performance of the functionalized PSA is manifested in a surface tension of at least 60 mN/m and preferably of at least 65 mN/m, in a contact angle with water of less than 35° and preferably less than 30°, and in a rapid transport rate of a test liquid in a test channel (functional test) of at least 25 mm/s. Correspondingly good wetting performance (contact angle and functional test) is also observed after a long storage time, which can be simulated by accelerated aging of at least six weeks at elevated temperatures of, for example, 40° C. and 70° C. The very good storage stability (aging stability) of the functionalized PSA tape of the invention is manifested in this case through the fact that the wetting properties (contact angle and fill time of the channel in the functional test) differ by not more than 25%, after storage for six weeks at 40° C. and preferably at 70° C., from the original value (without storage).

Solvents used for the surfactant-containing coating solution are water, alcohols, ethanol or higher-boiling alcohols such as n-butanol or ethoxyethanol, ketones such as butanone, esters such as ethyl acetate, alkanes such as hexane, toluene or mixtures of the aforementioned solvents. The selection of a suitable solvent is important since a homogeneous coating on the PSA is not achieved with every solvent. On the other hand, the solvent must not cause excessive swelling of the apolar PSA, since in that case the surfactant also migrates to a greater extent into the PSA and is therefore not available at the surface for improving the wettability. Solvents used for the surfactant-containing coating are therefore, in particular, alcohols such as ethanol, propanol, isopropanol or butanol or mixtures of these alcohols with water.

With further preference the surface of the PSA is functionalized by coating with an ionic, preferably anionic, surfactant, the coating preferably further comprising a binder selected more particularly from the group of polyvinyl alcohol, polyvinylbuteral, polyacrylate or cellulose derivative. The surfactant-containing coating may further comprise film-forming binders of the kind used, for example, in the printing inks industry. As binders it is preferred to use polymers or copolymers with carboxyl, carboxylate, amine, ammonium, amide or alcohol functionalities and, with particular preference, corresponding water-soluble polymers or copolymers. The polymer serves as a binder and/or thickener for the surfactant-containing coating. Suitable binders, by way of example and without restriction, include homopolymers or copolymers such as polyvinylpyrrolidone, polyvinylbuteral, polyester, polyacrylate, poly(meth)acrylic acid, polyvinyl acetate, partially hydrolyzed polyvinyl acetate, polyvinyl alcohol, poly(meth)acrylamide polyamide, polyethylene glycol, polypropylene glycol, cellulose derivatives. The stated polymers can also be used in the form of dispersions.

One preferred version of the surfactant-containing coating of the invention uses a polyvinyl alcohol binder. Polyvinyl alcohols are prepared from polyvinyl acetate by hydrolysis of the acetate functionality. The properties of the polyvinyl alcohols may be controlled via the molecular weight of the polymer and via the degree of hydrolysis. It is preferred to use a polyvinyl alcohol having a degree of hydrolysis of >85 mol %, and more preferably of >95 mol %. This class of polymer is exemplified by Mowiol® from Kuraray Inc. or Polyviol® from Wacker Chemie GmbH.

A further preferred version of the surfactant-containing coating of the invention uses a polyvinylbuteral binder. Polyvinylbuteral is obtained from polyvinyl alcohol by esterification with n-butylaldehyde. The properties are determined by the molecular weight, the degree of hydrolysis and the degree of acetalization. Preference is given to using a polyvinylbuteral with a vinyl acetal content of >75% by weight, a vinyl acetate content of <5% by weight and a vinyl alcohol content of 15% to 30% by weight. This class of polymer is exemplified by Mowital® from Kuraray Inc. or Pioloform® from Wacker Chemie GmbH.

A further preferred version of the surfactant-containing coating of the invention uses a cellulose derivative as binder. Particularly suitable in this context are carboxymethylcellulose (CMC) and cellulose acetate. These derivatives of cellulose, through reaction of some of the hydroxyl groups of the cellulose with chloroacetic acid, become the corresponding ethers. In the alkaline form, as the sodium salt, the carboxymethylcelluloses are readily soluble in water. This class of substance is exemplified by Blanose® CMC 7MF from Hercules Inc. and Walocel® CRT from Dow Wolff Cellulosics Inc.

The surfactant-containing coating is applied over the full area or partially, as a pattern, over the entire area or partially, in separate, mutually delimited regions, to the surface of the PSA of the PSA tape of the invention. Coating methods suitable with advantage for full-area application are those such as, for example, spray coating, patterned roll coating, Mayer bar coating, multi-roll applicator coating, condensation coating, aerosol coating, and printing methods as well.

Coating may take place in the form of one or more stripes in longitudinal direction (machine direction) and/or, where appropriate, in cross direction. Furthermore, the coating may be applied in the form of pattern dots by means, for example, of screen printing or flexographic printing, it also being possible for the dots to have different sizes and/or different distributions, and with application taking place by means of gravure printing, in bridges which connect in the machine and cross directions, or by pattern printing. The coating may have a domed form (produced by screen printing) or else an alternative pattern such as latices, stripes or zigzag lines. Partial coating is accomplished preferably with a printing process such as screen, inkjet or flexographic printing.

In order to obtain improved wettability and/or anchorage of the functional coating to the surface of the PSA, it is possible here as well, before applying the surfactant-containing coating, to apply an additional primer coating or to carry out physical pretreatment methods, preferably corona treatment.

A typical application of the PSA tape of the invention is in medical diagnostic strips or as a cover for channels of microfluidic devices. In these applications, the PSA tape of the invention, with its hydrophilic functionalization, ensures transport of the biological fluid through the measuring channel or the channels. This transport must be ensured, reliably and with equal speed, even after a prolonged storage period (storage time of the diagnostic strip). The detection reactions and enzyme reactions with the biological fluids, as are employed in the microfluidic devices and biosensors, such as the detection of the blood sugar content, for example, are unaffected by the functionalized PSA tape or its ingredients. The tape features very high compatibility with these detection reactions and enzyme reactions.

### Test Methods

### Surface Tension and Contact Angle Measurement

The measurement of the contact angle with water and of the surface tension on solid surfaces takes place in accordance with EN 828:1997 using a G2/G402 instrument from Krüss GmbH. The surface tension is determined by the Owens-Wendt-Rabel&Kaeble method, by measuring the contact angle with deionized water and diiodomethane. The values are obtained in each case from the averaging of four results.

The channel test is also carried out after storage at 23° C., 40° C. and 70° C., in order to test the aging stability and storage stability.

### Functional Test

To assess the transport characteristics of an aqueous test fluid, a capillary test is carried out. This is done by placing the application orifice of the test channel into a test fluid consisting of deionized water and 1% by weight of naphthol red. The transport rate of the test fluid in the test channel is measured by means of a video camera between two marks at a distance of 4 mm from one another. The test channel has a width of 1.0 mm and a height of 75 μm, the PSA tape of the invention forming one wall of the tests channel.

The channel test is also carried out after storage at 23° C., 40° C. and 70° C., in order to test the aging stability and storage stability.

Biological fluids such as blood are likewise used as test fluids. However, biological fluids such as blood are less suitable as test fluids, since they are subject to fluctuations in properties. Thus, for example, the viscosity of blood fluctuates very sharply, as a function of the hematocrit value.

### Bond Strength

The peel strength (bond strength) was tested in a method based on PSTC-1. A strip of the PSA tape 2 cm wide is adhered to the test substrate (ground steel plate) by running a 5 kg roller back and forth over the adhered tape five times. The plate is clamped in and the self-adhesive strip is pulled by its free end in a tensile testing machine under a peel angle of 180° at a speed of 300 mm/min; the force required in order to pull the strip is recorded. The results are reported in N/cm and are averaged over three measurements. All of the measurements are conducted at room temperature.

The intention of the text below is to illustrate the invention by means of a number of examples without wishing thereby to restrict the invention unnecessarily.

### EXAMPLES

The single-sided PSA tapes referred to in the examples were produced as follows:

A reactor conventional for free-radical polymerization was charged with 28 kg of acrylic acid, 292 kg of 2-ethylhexyl acrylate, 40 kg of methyl acrylate and 300 kg of acetone/isopropanol (97:3). After nitrogen gas had been passed through the reactor for 45 minutes, with stirring, the reactor was heated to 58° C. and 0.2 kg of azoisobutyronitrile (AIBN, Vazo 64®, DuPont) was added. Subsequently the external heating bath was heated to 75° C., and the reaction was carried out constantly at this external temperature. After a reaction time of 1 h a further 0.2 kg of AIBN was added. After 3 h and after 6 h the mixture was diluted with 150 kg each time of acetone/isopropanol (97:3). In order to reduce the residual initiators, 0.4 kg portions of bis(4-tert-butylcyclohexanyl) peroxy-dicarbonate (Perkadox 16®, Akzo Nobel) were added after 8 h and after 10 h. After a reaction time of 22 h the reaction was discontinued and cooled to room temperature.

Following the polymerization, the polymer was diluted with isopropanol to a solids content of 25% and then blended with 0.4% by weight of aluminum(III) acetylacetonate, with stirring. Subsequently the polymer solution was coated by means of a comma bar to one side of a 50 μm polyester backing (Hostaphan RN 50 from Mitsubishi Polyesterfilms GmbH) pretreated by corona beforehand. Drying took place at 120° C. for 10 minutes. The coat weight after drying is 15 g/m². The adhesive was subsequently lined with a release paper.

This pressure-sensitive adhesive tape was used to produce all of the embodiments of the examples and counterexamples.

| Raw material | Manufacturer | Type of raw material |
|---|---|---|
| Surfactants | | |
| Lutensit A-BO | BASF AG | Na diisoctyl sulfosuccinate |
| Rewopol SB DO 75 | Degussa AG | Na diisoctyl sulfosuccinate |
| Tegopren W 5840 | Degussa AG | Siloxane ethoxylates |
| Zonyl FSO-100 | Du Pont Inc. | Nonionic fluorosurfactant |
| Rhodapex CO-433 | Rhodia Inc. | Ammonium ethoxy sulfate |
| Binders | | |
| Mowiol 4-98 | Kuraray Inc. | Polyvinyl alcohol |
| Blanose CMC 7MF | Hercules GmbH | Na carboxymethylcellulose |
| Pressure-adhesives | | |
| Aroset 5255 | Ashland Inc. | Acrylate PSA |

### Example 1

The release paper was removed from the PSA tape described above. The exposed PSA was then coated with a coating solution consisting of 15% by weight of Lutensit® A-BO from BASF AG in butanol, using a wire doctor. After the coating had been dried at 120° C. for 5 min, the adhesive was again lined with a release paper.

The functionalized PSA is notable for very good wetting properties (contact angle, functional test) which drop only slightly after the storage time. However, a decidedly low bond strength is observed.

### Example 2

In the same way as in example 1, the PSA of the PSA tape was coated with a solution of 1% by weight of Tegopren® 5840 from Evonik AG, 5% by weight of Rewopol® SB DO from Evonik GmbH, 40% by weight of water and 54% by weight of ethanol, and dried.

The functionalized PSA exhibits very good wetting properties, which again drop only slightly after the storage time.

### Example 3

The PSA side of the PSA tape is printed by a flexographic pattern printing process (diameter of the pattern dots 0.4 mm, distance of the pattern dots from one another 1.0 mm) with a hydrophilic printing ink consisting of 3% by weight of Rewopol® SB DO from Evonik GmbH and 2% by weight of Blanose CMC 7MF from Hercules GmbH in water.

The functionalized PSA exhibits very good wetting properties, which are also stable after the storage time. As a result of the pattern dot coating, the bond strength is significantly improved as compared to that of example 1.

### Example 4

The PSA side of the PSA tape is coated, by means of a patterned ceramic roller, with a surfactant-containing varnish consisting of 1.5% by weight of Zonyl® FSA from Du Pont Inc., 7.5% by weight of Mowiol 4-98 from Kuraray Inc. in water, thus producing individual pattern dots.

The functionalized PSA exhibits excellent wetting properties with a very high rate of fluid transport in the functional test. The wetting properties also change only slightly during the storage time. As a result of the coating with pattern dots, the bond strength here as well is significantly improved as compared with that of example 1.

Overview of the results of the examples

| | Unit | Example 1 | Example 2 | Example 3 | Example 4 |
|---|---|---|---|---|---|
| Backing film | | 50 μm PET | 50 μm PET | 50 μm PET | 50 μm PET |
| PSA | | polyacrylate | polyacrylate | polyacrylate | polyacrylate |
| Adhesive coat weight | g/m² | 15 | 15 | 15 | 15 |
| Bond strength to steel | N/cm | 1.5 | 1.8 | 2.4 | 2.1 |
| Surface tension | mN/m | 67 | 65 | 61 | 69 |
| Surface tension after | mN/m | 66 | 63 | 60 | 69 |
| 6 weeks at 40° C. | | | | | |
| Surface tension after | mN/m | 65 | 63 | 60 | 68 |
| 6 weeks at 70° C. | | | | | |
| Contact angle | ° | 23 | 26 | 29 | 20 |
| Contact angle after 6 | ° | 25 | 28 | 29 | 21 |
| weeks at 40° C. | | | | | |
| Contact angle after 6 | ° | 26 | 28 | 29 | 23 |
| weeks at 70° C. | | | | | |
| Channel test | mm/s | 49 | 42 | 31 | 59 |
| Channel test after 6 | mm/s | 43 | 41 | 29 | 56 |
| weeeks at 40° C. | | | | | |
| Channel test after 6 | mm/s | 39 | 40 | 30 | 53 |
| weeks at 70° C. | | | | | |

### Counterexamples

### Counterexample 1

The aforementioned PSA tape without a functional coating.

The surface tension measured on the surface of the adhesive is low. Spreading or transport of the aqueous test fluids on the surface of the adhesive does not take place. The test channels are non-functional.

### Counterexample 2

The PSA surface of the PSA tape was coated in the same way as in example 1 with a coating solution of 35% by weight Lutensit® A-BO from BASF AG in butanol, and dried.

This functionalized PSA exhibits very good wetting properties. The surface, however, is very waxy or soapy. It is almost impossible to adhere the PSA tape strongly to test plaques made of polyester, for example. This is reflected in the very poor bond strength values. In the channel test, the test fluid is observed to run underneath between the functionalized PSA and the bond substrate. Measurement is therefore not possible. It is impossible to use this PSA tape.

### Counterexample 3

The PSA surface of the PSA tape was coated in the same way as in example 1 with a coating solution of 20% by weight of Triton® X-100 from Dow Chemicals Inc. in water, and dried.

This functionalized PSA exhibits good wetting properties only immediately after coating. Even after a short storage time of 1 week, no improvement in wettability as compared with the non-functionalized PSA tape is observed. It is supposed that the surfactant migrates completely into the PSA and hence no longer shows any effect at the PSA surface. It is impossible to use this PSA tape.

### Counterexample 4

As a counterexample, example 8 from WO 02/085185 A1 was produced. This was done by preparing a PSA from 94% by weight of Aroset 5255 from Ashland Inc. and 6% by weight of Rhodapex CO-433 from Rhodia Inc. and coating it onto a 50 μm polyester backing (Hostaphan RN 50 from Mitsubishi Polyesterfilms GmbH) pretreated by corona beforehand. Drying took place at 120° C. for 10 minutes. The coat weight after drying was 15 g/m². After the coating step, the adhesive was lined with release paper.

The wetting properties of this hydrophilic adhesive are moderate. In the functional test, the filling of the test channel that is observed is slow.

Overview of the results of the counterexamples

| | | Counter- | Counter- | Counter- | |
|---|---|---|---|---|---|
| | Unit | example 1 | example 2 | example 3 | Counterexample 4 |
| Backing film | | 50 μm PET | 50 μm PET | 50 μm PET | 50 μm PET |
| PSA | | Polyacrylate | Polyacrylate | Polyacrylate | Polyacrylate |
| Adhesive coat weight | g/m² | 15 | 15 | 15 | 15 |
| Bond strength to steel | N/cm | 3.1 | 0.2 | 2.9 | 2.1 |
| Surface tension | mN/m | 14 | 70 | 71 | 56 |
| Surface tension after | mN/m | 13 | 69 | 49 | 55 |
| 6 weeks at 40° C. | | | | | |
| Surface tension after | mN/m | 13 | 68 | 43 | 55 |
| 6 weeks at 70° C. | | | | | |
| Contact angle | ° | 110 | 18 | 17 | 37 |
| Contact angle after 6 | ° | 106 | 21 | 56 | 38 |
| weeks at 40° C. | | | | | |
| Contact angle after 6 | ° | 101 | 23 | 68 | 38 |
| weeks at 70° C. | | | | | |
| Channel test | mm/s | — | —* | 58 | 12 |
| Channel test after 6 weeks | mm/s | — | —* | — | 10 |
| at 40° C. | | | | | |
| Channel test after 6 weeks | mm/s | — | —* | — | 11 |
| at 70° C. | | | | | |

*the channels cannot be produced because the bond strength is too low

What is claimed is:

1. Pressure-sensitive adhesive tape comprising a backing material coated on one or both sides with a pressure-sensitive adhesive, wherein at least one surface of pressure-sensitive adhesive is functionalized by an additional surfactant-containing coating, the functionalization of the surface of pressure-sensitive adhesive being retained even after a storage time of 6 weeks at 40° C., and the bond strength to steel of the functionalized pressure-sensitive adhesive being at least 0.5 N/cm.

2. Pressure-sensitive adhesive tape according to claim 1, wherein the pressure-sensitive adhesive is composed of one or more copolymers, with acrylate monomers forming the principal constituent.

3. Pressure-sensitive adhesive tape according to claim 1, wherein the coating for functionalizing the pressure-sensitive adhesive comprises at least one ionic surfactant.

4. Pressure-sensitive adhesive tape according to claim 1, wherein the coating for functionalizing the pressure-sensitive adhesive is composed, after drying, exclusively of a salt of a sulfosuccinic ester without further adjuvants.

5. Pressure-sensitive adhesive tape according to claim 1, which comprises a concentration of the surfactant or surfactants in the surfactant-containing coating for functionalizing the pressure-sensitive adhesive of not more than 30% by weight.

6. Pressure-sensitive adhesive tape according to claim 1, wherein the coating comprises a binder.

7. Pressure-sensitive adhesive tape according to claim 1, wherein the surfactant-containing coating is a dried solution, in a suitable solvent or in water, applied partially or over the full area to the pressure-sensitive adhesive.

8. Pressure-sensitive adhesive tape according to claim 1, wherein the pressure-sensitive adhesive functionalized by the surfactant-containing coating possesses the following properties:
a surface tension of at least 60 mN/m,
a contact angle with water of less than 350 and/or
a bond strength to steel of at least 1.0 N/cm.

9. Pressure-sensitive adhesive tape according to claim 1, wherein the functional properties of the pressure-sensitive adhesive functionalized by the surfactant-containing coating, which are characterized by the surface tension and the contact angle with water, differ by not more than 25%, after storage at 40° C. for 6 weeks from the original value (fresh value).

10. Pressure-sensitive adhesive tape according to claim 1, wherein the backing material is composed of a polyester film.

11. A device selected from the group consisting of diagnostic strips, biosensors, point-of-care devices and microfluidic devices by means of which biological fluids are analyzed, said device comprising a pressure-sensitive adhesive tape according to claim 1.

12. Process for producing a functionalized pressure-sensitive adhesive tape according to claim 1, comprising applying a coating solution from a solvent or water in which at least one surfactant has been dissolved to a pressure-sensitive adhesive tape, which is composed of a backing material coated on one or both sides with a pressure-sensitive adhesive, and drying the pressure-sensitive adhesive tape with the coating solution, so that, after drying, a surfactant-containing coating is obtained on the surface of the pressure-sensitive adhesive.

13. Process according to claim 12, where the coating solution comprises at least one anionic surfactant.
